(19) United States
(12) Patent Application Publication
(10) Pub. No.: US 2025/0286833 A1
(43) Pub. Date: Sep. 11, 2025

(54) EXTENDING A MANAGEMENT FABRIC TO PERIPHERAL DEVICES FOR PERFORMANCE AND POWER OPTIMIZATION

(71) Applicant: DELL PRODUCTS L.P., Round Rock, TX (US)

(72) Inventors: Mitchell Markow, Hutto, TX (US); Balasingh Samuel, Round Rock, TX (US); Abeye Teshome, Austin, TX (US)

(21) Appl. No.: 18/599,729

(22) Filed: Mar. 8, 2024

(51) Int. Cl. H04L 49/20; H04L 49/00

(52) U.S. Cl. CPC H04L 49/205; H04L 49/30

(57) ABSTRACT

An information handling system includes a managed device coupled to a processor by a data communication interface. The management device manages a managed device via a management fabric different from the data communication interface.

### FIELD OF THE DISCLOSURE

This disclosure generally relates to information handling systems, and more particularly relates to extending a management fabric to peripheral devices for performance and power optimization in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a managed device coupled to a processor by a data communication interface. The management device may manage a managed device via a management fabric different from the data communication interface.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure;

FIG. 2 is a flowchart illustrating a method for extending a management fabric to peripheral devices for performance and power optimization according to an embodiment of the present disclosure; and

FIG. 3 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

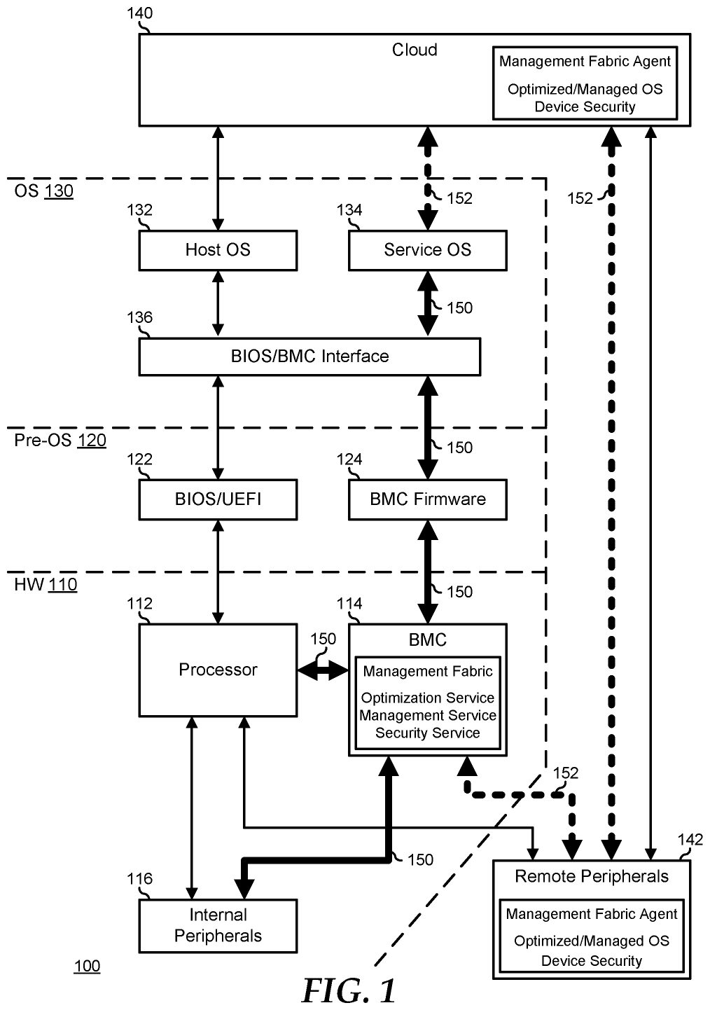

FIG. 1 illustrates hierarchical view of an information handling system 100 within a larger ecosystem that includes a cloud 140 and remote peripherals 142. Information handling system 100 includes a hardware layer 110, a pre-operating system (pre-OS) layer 120, and an OS layer 130. Hardware layer 110 includes a processor 112, a baseboard management controller (BMC) 114, and internal peripherals 116. Processor 112 may be understood to represent one or more central processing units (CPUs), controllers, or the like, and associated processing elements that operate to instantiate a host processing environment (that is, various elements of pre-OS layer 120 and OS layer 130, as described below) on information handling system 100. BMC 114 may represent one or more CPUs, controllers, or the like, and associated processing elements that operate to instantiate a management processing environment on information handling system 100 (that is, various elements of pre-OS layer 120 and OS layer 130, as described below).

Internal peripherals 116 represent various hardware elements that are provided in information handling system 100, typically within the confines of a case of the information handling system, that provide various functionalities or features that are not typically associated with the core processing functionality of processor 112. Internal peripherals 116 may represent various hardware elements that are provided “down,” that is, fabricated on a printed circuit board (PCB) of information handling system 100. For example, a hardware element that is down on a PCB of information handling system 100 may include integrated network interface controllers, audio controllers, video or graphics controllers, or the like. Internal peripherals 116 may further represent various hardware elements that can be installed into the PCB of information handling system 100 or removed from the PCB as needed or desired. For example, a hardware element that can be installed or removed from information handling system 100 may include stand-alone network interface cards (NICs), audio cards, video or graphics cards, or the like. Internal peripherals 116 are connected to processor 112 and BMC 114 via one or more data communication interfaces provided within hardware 110.

Pre-OS level 120 includes Basic Input/Output System (BIOS)/Universal Extensible Firmware Interface (UEFI) firmware 122 and BMC firmware 124. BIOS/UEFI 122 represents code operable to detect the elements of hardware 110, and particularly of processor 112, internal peripherals 116, and remote peripherals 142, to provide drivers initialize the elements, and to access the elements during run time operations. BMC firmware 124 represents code operable to detect the elements of hardware 110, and particularly of BMC 114, to provide drivers initialize the elements, and to access the elements during run time operations. The code associated with BIOS/UEFI 122 and with BMC firmware 124 is typically stored on non-volatile memory devices associated with processor 112 and BMC 114, respectively. However, in operation pre-OS level 120 represents pre-OS operating environments instantiated on processor 112 for BIOS/UEFI 122, and on BMC 114 for BMC firmware 124.

OS level 130 includes a host OS 132, a service OS 134, and a BIOS/BMC interface 136. Host OS 132 represents an operating system that is instantiated on processor 112 and that is launched by BIOS/UEFI 122 to provide an operating environment to perform the functions and features associated with the typical use of information handling system 100. For example, host OS 132 may provide an environment that permits a user of information handling system 100 to launch programs and applications to perform desired functions, as needed or desired. In another example, host OS 132 may represent a commercial operating system, such as a Windows OS, a Linux OS, or the like, or may represent a dedicated operating system associated with a particular controller or usage model, as needed or desired. Service OS 134 represents an operating environment that is instantiated on BMC 114 to provide a user interface to the functions and features of the BMC through a network connected mechanism. In particular, service OS 134 permits a technician who is remote from information handling system 100 to access BMC 114. BIOS/BMC interface 136 provides a bridge between the operating environment established on processor 112 and the operating environment established on BMC 114, as described further below.

Cloud 140 broadly represents all elements of the ecosystem that reside outside the confines of information handling system 100. More particularly, cloud 140 may represent networking resources, such as a local area network, an access network, an internet, the Internet, or the like, that permit information handling system 100 to communicate information outside the confines of the information handling system. Cloud 140 may further represent processing resources that may be called upon by information handling system 100, such as near-, mid-, or far-edge processing resources, or the like. Cloud 140 is typically accessed by information handling system 100 by a network connection, a wireless connection, a near-field connection, or the like. Cloud 140 may be accessed by information handling system 100 via one or more hardware element of hardware 100. However the access to the hardware elements of hardware 100 will be mediated through one or more of the elements of pre-OS layer 120 and of OS layer 130, as needed or desired.

Remote peripherals 142 represent various devices that are situated outside the confines of information handling system 100, and that provide various functionalities or features that are not typically associated with the core processing functionality of processor 112. Examples of remote peripherals 142 may include docks or other expansion devices, smart displays, monitors, or the like, camera/video devices, microphones, speakers, or other multimedia devices, mobile devices such as cell phones, tablet devices, or other mobile devices that may be included in a personal network associated with information handling system 100, or other remotely connected devices that are situated outside the confines of information handling system 100. Remote peripherals 142 may be directly connected to information handling system 100, such as through a network connection, a wireless connection such as a WiFi connection, a Bluetooth connection, and Near Field Communication (NFC) connection, or the like, or the remote peripherals may be connected to the information handling system via cloud 140, for example where the remote peripherals include a native network connection.

Information handling system 100 provides a host environment across hardware 110, pre-OS layer 120, and OS layer 130. In particular, the host environment consists of processor 112, internal peripherals 116, BIOS/UEFI 122, and host OS 132. The host environment is illustrated by the light solid lines interconnecting the elements of the host environment. Information handling system 100 further provides a management environment 150 across hardware 110, pre-OS layer 120, and OS layer 130. Management environment 150 represents an out-of-band control plane for monitoring, managing, and maintaining the operations of information handling system 100. In particular, management environment 150 provides an anchor and root of trust for information handling system 100, data collection, thermal, battery, and power supply control for the information handling system, an out-of-band mechanism to provide firmware updates, and the like.

As such, management environment 150 consists of BMC 114, control plane elements of internal peripherals 116, BMC firmware 124, service OS 132, and BIOS/UEFI interface 136, as illustrated by the heavy solid lines interconnecting the elements of the management environment. BMC 114 operates to instantiate management environment 150 to monitor, manage, and maintain the elements of processor 112 and of internal peripherals 116 through various out-of-band data communication interfaces, such as an Inter-Integrated Circuit (I2C) interface, an Improved I2C (I3C) interface, a Serial Peripheral Interface (SPI) interface, an enhanced SPI (ePSI) interface, or other types of data communication interfaces. Further, through the action of BIOS/BMC interface 136, management environment 150 is provided with hooks into the host environment to monitor, manage, and maintain various aspects of the host environment, as needed or desired.

It has been understood by the inventors of the current disclosure that, as consumer demand for a seamless computing ecosystem increases, management of the resources of the ecosystem must evolve past the management of the resources only of the information handling system, as described above with respect to the management environment of information handling system 100. In particular, consumers are demanding broader integration of the intelligent device to peripheral management experience, discovery responsiveness, auto connectivity framework, multi-system performance per watt, multi device security across the entire ecosystem, and the like. In a particular embodiment, information handling system 100 operates to extend the control and data plane established by management environment 150 to elements outside the confines of the information handling system. In particular, BMC 114 instantiates a management fabric 152 that extends the functionality of management environment 150 to cloud 140 and to remote peripherals 142. As such, management fabric 152 represents a mechanism whereby BMC 114 can communicate with cloud 140 and with remote peripherals 142 to monitor, manage, and maintain the activities of cloud-based applications and features, and of the remote peripherals.

In particular, management fabric 152 may be incorporated into the code associated with BMC firmware 124, with service OS 134, or within other elements of information handling system 100. Management fabric 152 provides a standardized interface with cloud 140 and with remote peripherals 142 to enable secure and verified communications for device management and optimization. Cloud-based applications within cloud 140, and remote peripherals 142, in order to become manageable via management fabric 152, will incorporate a management fabric agent that complements the management fabric and permits the cloud-based applications and the remote peripherals to be managed by BMC 150. The management fabric agent incorporates communication security modules that permit the root of trust for management activities to be rooted in BMC 114. Once the communications under management fabric 152 are secured and rooted, the management fabric agent provides BMC 114 with access to management and optimization capabilities within the cloud-based applications and remote peripherals 142. In accessing the management capabilities of the cloud-based applications and remote peripherals 142, BMC 114 may manage device sleep- or power-states, firmware updates, custom device states, or the like. In accessing the optimization capabilities of the cloud-based applications and remote peripherals 142, BMC 114 may optimize the operating state of the workloads and operating conditions to achieve a particular goal, such as low-power operations, high-performance operations, battery-longevity operations, low-acoustics operations, or the like.

In a particular embodiment, management fabric 152 represents a vendor specific protocol stack, including a physical interface layer that is provided on information handling system 100 and on remote peripherals 142. In this way, a proprietary management capability is provided on compliant information handling systems and remote peripherals, as needed or desired. In another embodiment, management fabric 152 represents a physical interface agnostic protocol stack that can utilize various data communication interfaces to carry management fabric protocol information between information handling system 100, cloud 140, and remote peripherals 142. For example, management fabric 152 may utilize a management-over-X (MoX) scheme, such as a management-over-Ethernet (MoE) scheme, or the like, where management fabric protocol information is encapsulated within data transactions native to another protocol, as needed or desired.

When information handling system 100 is in particular low-power states, such as a modern-standby state, BMC 114 remains powered and executing code to maintain management environment 150. In this way, BMC 114 retains the ability to manage the low-power operations of internal peripherals 116, powering the internal peripherals off and on, or otherwise suspending and resuming operations, as needed or desired to maintain a desired user experience. The existence of management fabric 152 provides the ability to extend this user experience management from within the confines of information handling system 100 to remote cloud 140 and to remote peripherals 142. That is, BMC 114 may now suspend or resume applications within cloud 140, and power off and on remote peripherals 142 to extend the user experience to the entire ecosystem.

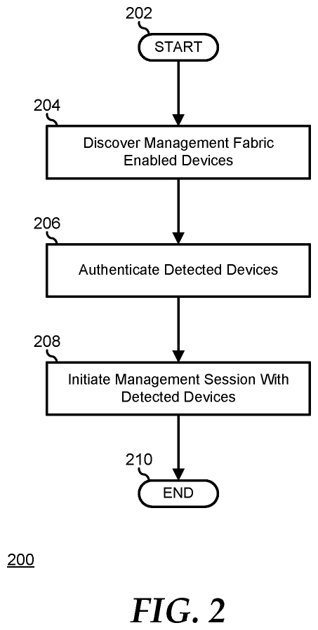

FIG. 2 illustrates a method 200 for extending a management fabric to peripheral devices for performance and power optimization, starting at block 202. A management device configured to establish a management fabric, as described above, operates to discover management fabric enabled devices within the ecosystem of an information handling system in block 204. The detected fabric enabled devices are authenticated by the management device in block 206. The management device initiates management sessions on the fabric enabled device in block 208, and the method ends in block 210. While a management fabric was described in the context of an information handling system with a BMC, as described above, this is not necessarily so.

For example, a management device may include a BMC, a management and optimization manager, or other element of an information handling system configured to monitor, manage, maintain, and optimize the operations of the information handling system and its associated peripheral devices, as needed or desired. Such a management device may operate in band with a host environment of the information handling system, or out of band from the host environment, as described above. In a particular case, the management fabric may be established by a separate optimization environment instantiated on an information handling system, as needed or desired. Note further that the management fabric agent was described as being associated with cloud-based applications or remote peripherals, as described above, but this is not necessarily the only cases for the implementation of a management fabric agent. For example, internal peripherals of an information handling system may likewise benefit from the inclusion of a management fabric agent, thereby providing a common framework for management of a wider range of devices, within the confines of the information handling system, or remote from the information handling system, as needed or desired.

As used herein a fabric may refer to a network topology, that is a set of physical data communication interface connections, that connects devices together. The network topology may include the supporting infrastructure needed to establish the connections, such as switches, routers, hubs, WiFi access points, and the like. A fabric may further refer to an abstracted overlay on the network topology that provides one or more separate virtualized data communication planes. The separate communication planes may each implement a particular protocol stack, and provide plane-dependent services and policies for data transfers on the communication planes. The data associated with a particular data plane can be encapsulated with plane-specific headers that identify the data as being associated with the particular data plane. Such fabric-dependent data packets can then be further encapsulated with other headers associated with the particular network topology, thereby making the data packets fabric-agnostic with respect to the physical network topology.

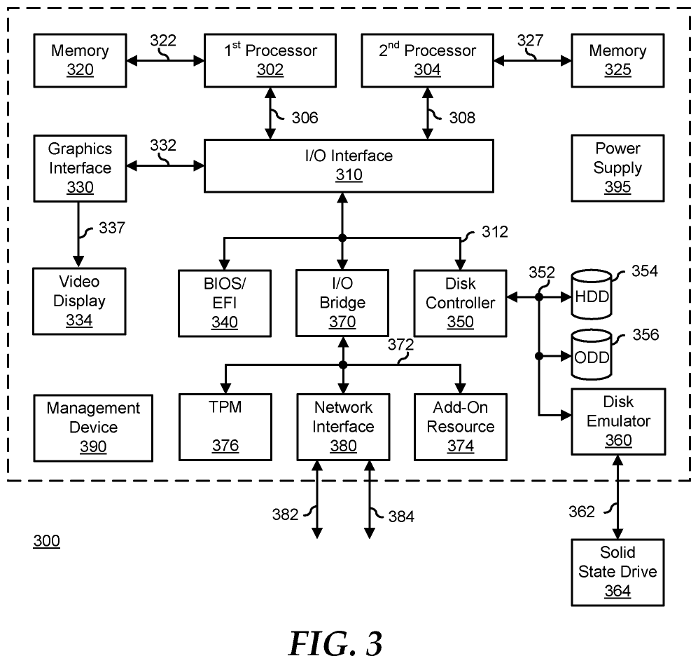

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a processor;
a management device; and
a managed device, wherein the managed device is coupled to the processor by a data communication interface, and wherein the management device manages the managed device via a management fabric different from the data communication interface.

2. The information handling system of claim 1, wherein, in managing the managed device, the management device is configured to authenticate the managed device via the management fabric.

3. The information handling system of claim 2, wherein, in managing the managed device, the management device is further configured to manage at least one of a device sleep-state, a device power-state, a firmware update, and a custom device state on the managed device via the management fabric.

4. The information handling system of claim 3, wherein in managing the managed device, the management device is further configured to perform an optimization operation on the managed device via the management fabric.

5. The information handling system of claim 4, wherein in performing the optimization operation, the management device is further configured to optimize the managed device for at least one of low-power operation, high-performance operation, battery-longevity operation, and low-acoustics operation.

6. The information handling system of claim 1, wherein the managed device is an internal peripheral device of the information handling system.

7. The information handling system of claim 1, wherein the managed device is a remote peripheral device of the information handling system.

8. The information handling system of claim 1, wherein the management device is instantiated by the processor.

9. The information handling system of claim 1, wherein the management device operates out of band from the processor.

10. The information handling system of claim 9, wherein the management device includes a baseboard management controller.

11. A method, comprising:
providing, in an information handling system, a processor;
providing, in the information handling system, a management device;
coupling a managed device to the processor by a data communication interface; and
managing, by the management device, the managed device via a management fabric different from the data communication interface.

12. The method of claim 11 wherein, in managing the managed device, the method further comprises authenticating, by the management device, the managed device via the management fabric.

13. The method of claim 12 wherein, in managing the managed device, the method further comprises managing, by the management device, at least one of a device sleep-state, a device power-state, a firmware update, and a custom device state on the managed device via the management fabric.

14. The method of claim 13 wherein in managing the managed device, the method further comprises performing, by the management device, an optimization operation on the managed device via the management fabric.

15. The method of claim 14 wherein in performing the optimization operation, the method further comprises optimizing the managed device for at least one of low-power operation, high-performance operation, battery-longevity operation, and low-acoustics operation.

16. The method of claim 11, wherein the managed device is an internal peripheral device of the information handling system.

17. The method of claim 11, wherein the managed device is a remote peripheral device of the information handling system.

18. The method of claim 11, wherein the management device is instantiated by the processor.

19. The method of claim 11, wherein the management device operates out of band from the processor.

20. An information handling system, comprising:
a processor;
a managed device coupled to the processor by a data communication interface; and
a management device configured to instantiate a management fabric on the data communication interface, and to manage the managed device via the management fabric.
